(19) United States
(12) Patent Application Publication
(10) Pub. No.: US 2024/0306066 A1
(43) Pub. Date: Sep. 12, 2024

(54) MEASUREMENT SCHEDULE ADJUSTMENT

(71) Applicant: QUALCOMM Incorporated, San Diego, CA (US)

(72) Inventors: Chunxia LI, Beijing (CN); Matthew Heng ZHANG, Shanghai (CN); Xiaoyu LI, Beijing (CN); Ling XIE, Beijing (CN); Liang ZHU, Shanghai (CN); Hua XU, Shanghai (CN); Wei GU, Wuxi (CN); Feng CHEN, Beijing (CN)

(21) Appl. No.: 18/264,376

(22) PCT Filed: Jan. 25, 2021
(86) PCT No.: PCT/CN2021/073566

§ 371 Date: Aug. 4, 2023

(51) Int. Cl. H04W 36/30; H04W 36/00

(52) U.S. Cl. CPC H04W 36/30; H04W 36/0088

(57) ABSTRACT

Techniques and apparatuses described herein enable a user equipment (UE) to adjust a measurement period indicated by a measurement schedule for neighbor cell measurement. For example, the UE may receive the measurement schedule. The measurement schedule may indicate a baseline measurement period. The UE may determine a measurement period (referred to as a determined measurement period) based at least in part on a received power value (such as an Srxlev) associated with the serving cell and a received power value for one or more neighbor cells.

### FIELD OF THE DISCLOSURE

Aspects of the present disclosure generally relate to wireless communication and to techniques and apparatuses for measurement schedule adjustment.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a 5G BS, a 5G Node B, or the like.

The above multiple access technologies have been adopted in various telecommunication standards to provide a common protocol that enables different wireless communication devices to communicate on a municipal, national, regional, and even global level. 5G, which may also be referred to as New Radio (NR), is a set of enhancements to the LTE mobile standard promulgated by the Third Generation Partnership Project (3GPP). 5G is designed to better support mobile broadband Internet access by improving spectral efficiency, lowering costs, improving services, making use of new spectrum, and better integrating with other open standards using OFDM with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and 5G technologies. Preferably, these improvements should be applicable to other multiple access technologies and the telecommunication standards that employ these technologies.

### SUMMARY

A UE may use a discontinuous reception (DRX) cycle to save power. One example of a DRX cycle may be used in an idle mode (e.g., a radio resource control (RRC) idle mode) of the UE. A DRX cycle includes a sleep time, in which receive circuitry of the UE is generally inactive or dormant, and an active time, in which the UE is monitoring for paging and/or receiving a data transmission, depending on the paging.

A UE in an idle mode may perform neighbor frequency measurements to identify suitable cells for cell reselection in case a serving cell of the UE becomes unsuitable. For example, the UE may perform a search or measurement with a measurement period that indicates how often the UE is to perform such a measurement. In some cases, a UE using an idle mode DRX cycle may perform neighbor frequency measurements. In such cases, the UE may awaken from the DRX cycle (e.g., enter an active time) to perform neighbor frequency measurements by monitoring a reference signal transmitted by the neighbor cell. However, in many deployments (such as with an LTE serving cell and a 5G neighbor cell), the UE may be configured to perform neighbor frequency measurements frequently, such as in each DRX cycle of the UE. Awakening the UE to perform neighbor frequency measurements frequently may reduce the sleep time of the UE, thereby increasing power consumption. Furthermore, in many situations (such as when neighbor cell measurements are poor relative to serving cell measurements), the UE may not benefit from frequent neighbor frequency measurements, since reselection is unlikely to occur, thereby consuming power of the UE for limited benefit.

Techniques and apparatuses described herein enable a UE to adjust a measurement period indicated by a measurement schedule for neighbor cell measurement. For example, the UE may receive the measurement schedule (e.g., via system information from a serving cell). In some aspects, the measurement schedule may be referred to as a neighbor frequency measurement schedule. The measurement schedule may indicate a baseline measurement period. The UE may determine a measurement period (referred to as a determined measurement period) based at least in part on a received power value (such as an Srxlev, defined elsewhere herein) associated with the serving cell and a received power value for one or more neighbor cells. For example, the UE may lengthen the determined measurement period (meaning relatively fewer neighbor cell measurements, such as fewer than every DRX cycle) when the one or more neighbor cells are associated with a lower received power value based at least in part on one or more thresholds, and may shorten the determined measurement period (meaning relatively more neighbor cell measurements) when the one or more neighbor cells are associated with a higher received power based at least in part on one or more thresholds and/or the serving cell is associated with a lower received power. Thus, the UE may adjust the measurement period for neighbor frequency measurement, thereby reducing power consumption of the UE and improving performance of DRX. Furthermore, the UE may expedite inter radio access technology (RAT) reselection in an out-of-service (OOS) case by scheduling measurement on a neighbor list of the UE if the serving cell and the one or more neighbor cells are both associated with lower received power values, as described in more detail elsewhere herein.

In some aspects, a method of wireless communication performed by a user equipment (UE) includes receiving, from a serving cell, information indicating a measurement schedule for measurement of a neighbor cell; determining a measurement period for the measurement schedule based at least in part on a received power value associated with the serving cell and on comparing the received power value of the neighbor cell to a given threshold; and performing one or more neighbor cell measurements in accordance with the determined measurement period.

In some aspects, a UE for wireless communication includes a memory; and one or more processors operatively coupled to the memory, the memory and the one or more processors configured to: receive, from a serving cell, information indicating a measurement schedule for measurement of a neighbor cell; determine a measurement period for the measurement schedule based at least in part on a received power value associated with the serving cell and on comparing the received power value of the neighbor cell to a given threshold; and perform one or more neighbor cell measurements in accordance with the determined measurement period.

In some aspects, a non-transitory computer-readable medium storing a set of instructions for wireless communication includes one or more instructions that, when executed by one or more processors of a UE, cause the UE to: receive, from a serving cell, information indicating a measurement schedule for measurement of a neighbor cell; determine a measurement period for the measurement schedule based at least in part on a received power value associated with the serving cell and on comparing the received power value of the neighbor cell to a given threshold; and perform one or more neighbor cell measurements in accordance with the determined measurement period.

In some aspects, an apparatus for wireless communication includes means for receiving, from a serving cell, information indicating a measurement schedule for measurement of a neighbor cell; means for determining a measurement period for the measurement schedule based at least in part on a received power value associated with the serving cell and on comparing the received power value of the neighbor cell to a given threshold; and means for performing one or more neighbor cell measurements in accordance with the determined measurement period.

Aspects generally include a method, apparatus, system, computer program product, non-transitory computer-readable medium, user equipment, base station, wireless communication device, and/or processing system as substantially described with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is diagram illustrating an example of a wireless network.

FIG. 2 is a diagram illustrating an example of a base station in communication with a UE in a wireless network.

FIG. 3 is a diagram illustrating an example of adjustment of a measurement schedule based at least in part on received power values, in accordance with various aspects of the present disclosure.

FIG. 4 is a diagram illustrating an example method for the determination of a measurement period, in accordance with various aspects of the present disclosure.

FIG. 5 is a flowchart of an example method of wireless communication, in accordance with various aspects of the present disclosure.

FIG. 6 is a block diagram of an example apparatus for wireless communication, in accordance with various aspects of the present disclosure.

FIG. 7 is a diagram illustrating an example of a hardware implementation for an apparatus employing a processing system, in accordance with various aspects of the present disclosure.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

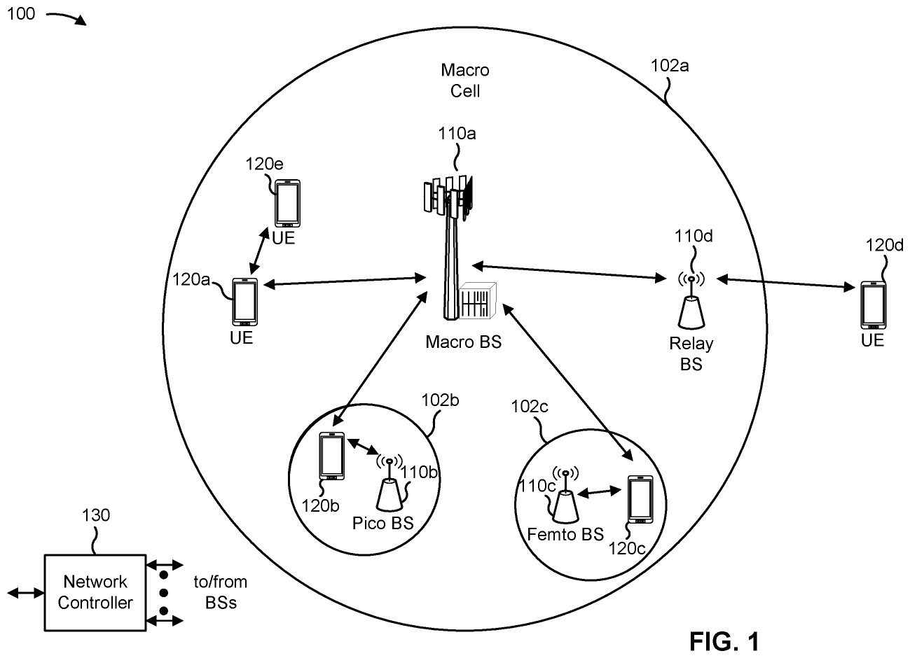

FIG. 1 is a diagram illustrating a wireless network 100 in which aspects of the present disclosure may be practiced. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as a 5G BS, a Node B, a gNB, a 5G NB, an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used. A UE may be associated with a serving cell, which is a cell with which the UE has registered and on which the UE has camped. If the UE initiates a connection (e.g., a radio resource control connection), the UE may initiate the connection with the serving cell.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “5G BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, or the like.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, 5G RAT networks may be deployed. In some aspects, a UE may reselect from a serving cell associated with one RAT to a neighbor cell associated with another RAT, for example, based at least in part on a measurement period determined by the UE in accordance with the techniques and apparatuses described herein.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

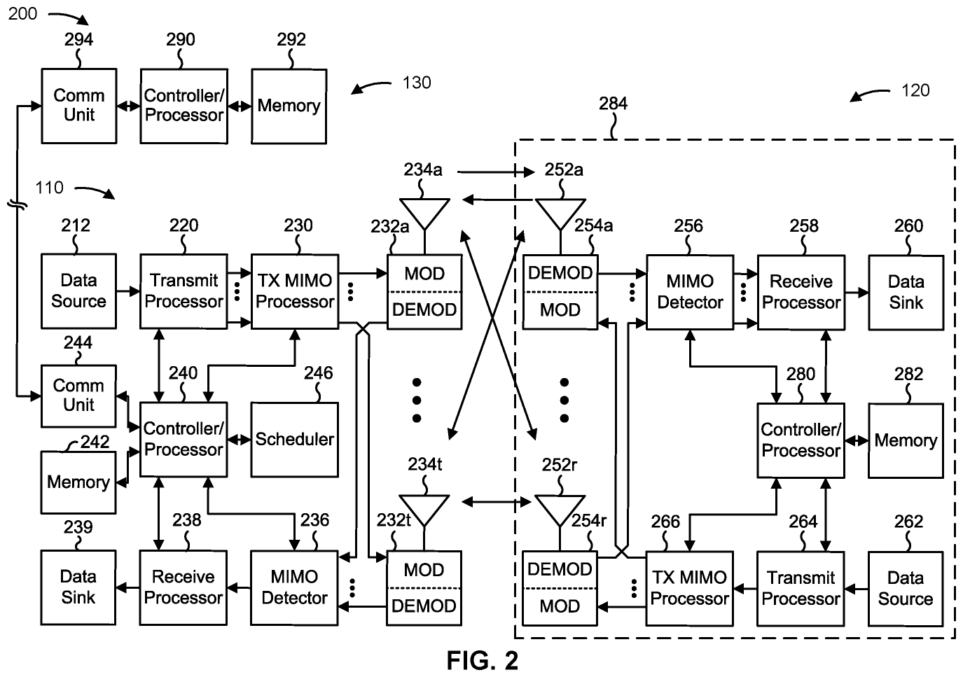

FIG. 2 is a diagram illustrating an example 200 of a base station 110 in communication with a UE 120 in a wireless network 100. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, may select a modulation and coding scheme (MCS) for each UE based at least in part on channel quality indicators (CQIs) received from the UE, process (e.g., encode and modulate) the data for each UE based at least in part on the MCS selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS), a phase tracking reference signal (PTRS), and/or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive (RX) processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein. A scheduler 246 may schedule UEs for data transmission on the downlink and/or uplink.

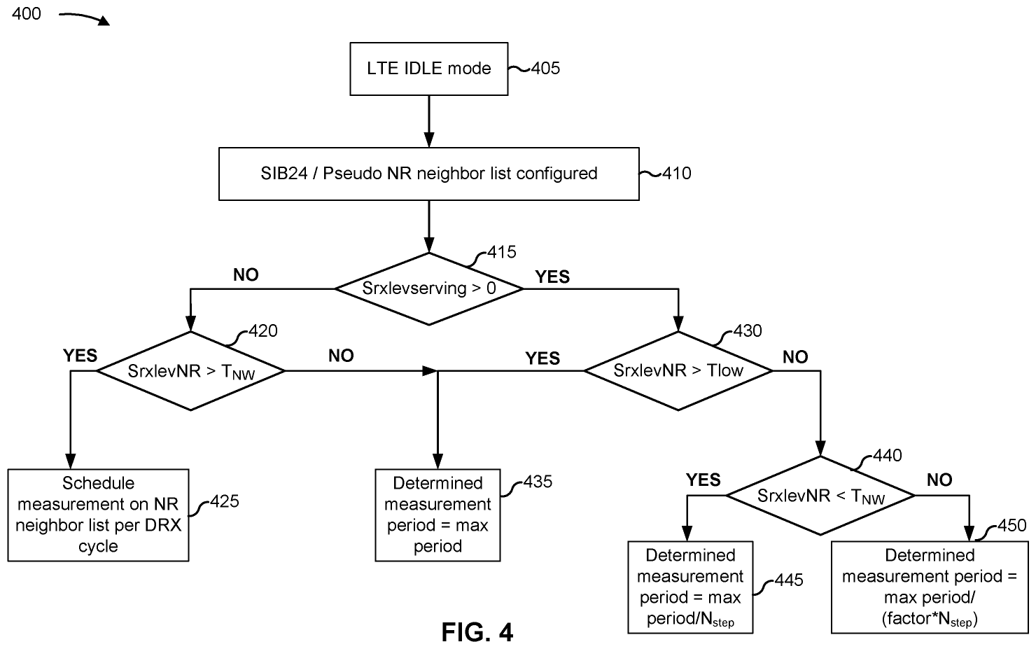

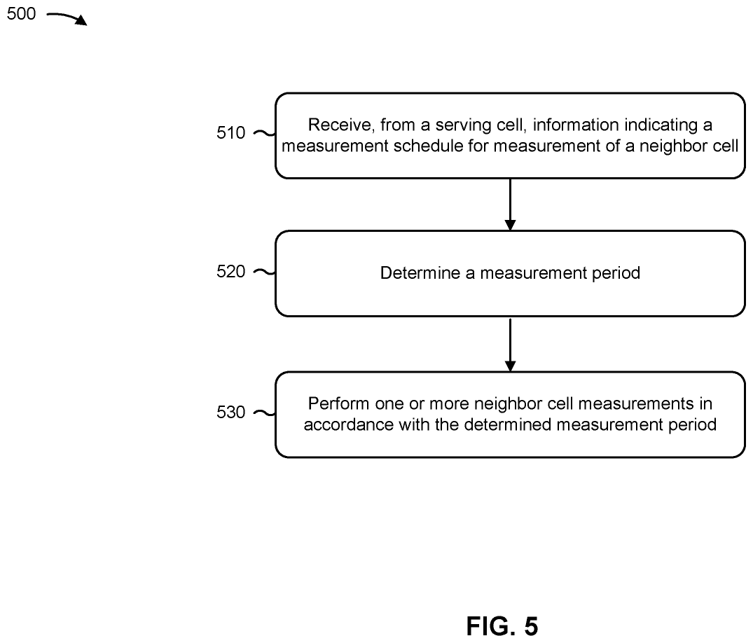

Controller/processor 240 of base station 110, controller/processor 280 of UE 120, and/or any other component(s) of FIG. 2 may perform one or more techniques associated with measurement schedule adjustment, as described in more detail elsewhere herein. For example, controller/processor 240 of base station 110, controller/processor 280 of UE 120, and/or any other component(s) of FIG. 2 may perform or direct operations of, for example, method 400 of FIG. 4, method 500 of FIG. 5, and/or other processes as described herein. Memories 242 and 282 may store data and program codes for BS 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, method 400 of FIG. 4, method 500 of FIG. 5, and/or other processes as described herein. In some aspects, executing instructions may include running the instructions, converting the instructions, compiling the instructions, and/or interpreting the instructions, among other examples.

As indicated above, FIG. 2 is provided as an example. Other examples may differ from what is described with regard to FIG. 2.

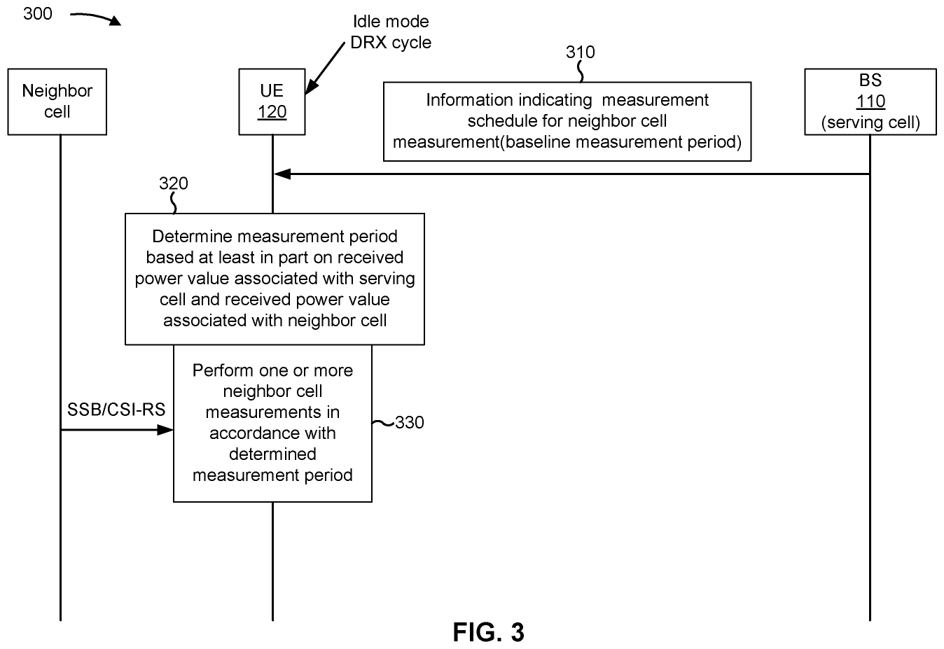

FIG. 3 is a diagram illustrating an example 300 of adjustment of a measurement schedule based at least in part on received power values, in accordance with various aspects of the present disclosure. As shown, example 300 includes a UE 120, a BS 110 associated with a serving cell, and a neighbor cell. The neighbor cell may be provided by a BS 110 (e.g., the same BS 110 that provides the serving cell, or a different BS 110 than the BS 110 that provides the serving cell). In some aspects, the serving cell is associated with a first radio access technology (RAT) and the neighbor cell is associated with a second RAT. As one example, the first RAT may be LTE and the second RAT may be 5G, though other combinations of first RAT and second RAT may be used.

As shown, the UE 120 may be in an idle mode, such as an RRC idle mode. An idle mode is a mode in which the UE 120 is registered with a public land mobile network (PLMN) and is not associated with an active connection (e.g., an active RRC connection). In the idle mode, the UE 120 may perform cell reselection mobility operations, such as based at least in part on system information, as described below. The UE 120 may be camped on the serving cell. As further shown, the UE 120 may be associated with a DRX cycle. For example, the DRX cycle may include active times and inactive times. In an active time, the UE 120 may monitor for paging (e.g., may be awake). If paging is received in an active time, the UE 120 may remain awake to receive further data. The UE 120 may also awaken (e.g., enter an active time) to perform cell reselection mobility operations, as described below.

At 310, the UE 120 may receive, from the serving cell, information indicating a measurement schedule. For example, the information indicating the measurement schedule may be provided via a system information block (SIB) such as SIB24. SIB24 may carry information for inter-RAT neighbor cell reselection, such as for an LTE-to-NR (L2NR) reselection. In some aspects, the information indicating the measurement schedule may be provided via a pseudo-configuration. A pseudo-configuration may include a pseudo-database, such as may be provided or maintained in the non-access stratum. For example, the pseudo-configuration may indicate a neighbor frequency list, which may be saved according to a background public land mobile network (BPLMN). After camping on a serving cell, the non-access stratum may send the neighbor frequency list to a radio resource control (RRC) function of the UE.

The measurement schedule may indicate a neighbor cell list, such as an NR neighbor cell list. A neighbor cell list includes information identifying a set of neighbor cells (which may include the neighbor cell of example 300) for which the UE 120 is to perform one or more neighbor cell measurements. In some aspects, the measurement schedule may indicate a baseline measurement period. A baseline measurement period is a measurement period indicated by the information indicating the measurement schedule. A measurement period may indicate how often the UE 120 is to perform a neighbor cell measurement. In some aspects, the baseline measurement period may be defined relative to a DRX cycle of the UE 120. For example, the baseline measurement period may be indicated via a parameter T_{measure,NR}, which may indicate a number of DRX cycles between neighbor cell measurements. In many scenarios, T_{measure,NR} may be equal to 1, meaning that the UE 120 may perform neighbor cell measurements in each DRX cycle, thereby consuming battery resources of the UE 120. A neighbor cell is any cell that is a potential target for selection as a serving cell. In some aspects, a neighbor cell is a cell identified by a neighbor cell list.

At 320, the UE 120 may determine a measurement period, which is referred to herein as a determined measurement period. The UE 120 may determine the measurement period based at least in part on a received power value associated with the serving cell and a received power value associated with the neighbor cell. In some aspects, the received power values may be cell selection receive level (Srxlev) values associated with the serving cell and the neighbor cell, respectively. Srxlev may be based at least in part on a cell measurement performed by the UE 120 on a reference signal, such as a reference signal received power (RSRP) measurement, a reference signal received quality (RSRQ) measurement, or the like. For example, for a cell measurement Qrxlevmeas, Srxlev may be equal to (Qrxlevmeas−Qrxlevmin), where Qrxlevmin is a minimum receive level for a cell. A typical value of Qrxlevmin is −128 dBm, and Qrxlevmin can be indicated via a SIB such as SIB1.

A reselection threshold for the serving cell may be defined based at least in part on the Srxlev. For example, if the Srxlev of the serving cell is less than zero (indicating that the received power value is less than the configured value of Qrxlevmin), then the UE 120 may determine that reselection is to be performed for the serving cell (e.g., that the received power level is below the reselection threshold). It should be understood that differences in the reselection threshold are contemplated. For example, the reselection threshold may be satisfied by an Srxlev that is greater than or equal to zero, or by an Srxlev that is greater than zero, in various implementations.

The UE 120 may determine whether to perform cell reselection based at least in part on a neighbor selection threshold. A neighbor selection threshold for a neighbor cell may be defined based at least in part on an offset Qoffset. The UE 120 may select a neighbor cell for reselection if the neighbor selection threshold is satisfied for the neighbor cell, where the neighbor selection threshold is defined as: (RSRP Serving Cell)+Qhyst<(RSRP Neighbor cell)−Qoffset, where Qhyst is a hysteresis value (e.g., 2 dBm). Thus, the UE 120 may determine whether to perform cell reselection based at least in part on whether an RSRP of a neighbor cell is stronger than an RSRP of a serving cell by at least Qoffset.

In some aspects, the determined measurement period may be based at least in part on a given threshold. The term “given threshold” is used to distinguish the given threshold from the neighbor selection threshold and the reselection threshold. The given threshold may be referred to herein as T_{low}. The given threshold may specify a received power value threshold for the neighbor cell, and may be lower than the neighbor selection threshold. In some aspects, if the received power value (e.g., Srxlev) for the neighbor cell is below the value specified by T_{low}, and if the received power value for the serving cell is greater than the reselection threshold, then the UE 120 may set the determined measurement period to a maximum search or measurement (search/measurement) period (sometimes referred to herein as a maximum measurement period). For example, the maximum search/measurement period may be longer than one DRX cycle. Thus, the UE 120 decreases the frequency of neighbor cell measurements when neighbor cell reselection is unlikely (due to the relatively weak neighbor cell received power value and the relatively strong serving cell received power value), thereby conserving power and measurement resources of the UE 120. The value of the given threshold can be preconfigured for the UE 120, signaled by the BS 110, specified in a wireless communication standard, or the like.

In some aspects, the determined measurement period may be based at least in part on the reselection threshold and the neighbor selection threshold. For example, if the received power level of the serving cell is greater than the reselection threshold and the received power level of the neighbor cell fails to satisfy the neighbor selection threshold (meaning that a cell reselection criterion associated with the neighbor selection threshold is not met), then the UE 120 may determine the determined measurement period to be shorter than the maximum search/measurement period. For example, the UE 120 may determine the determined measurement period based at least in part on a value Nₛₜₑₚ, which may specify a modification to shorten the maximum search/measurement period, or to lengthen the baseline measurement period. In some aspects, the UE 120 may determine the determined measurement period based at least in part on a value Nₛₜₑₚ due to the received power value for the neighbor cell satisfying T_{low} (e.g., being between T_{low} and the neighbor selection threshold). Thus, the UE 120 may determine a measurement period between the maximum search/measurement period and the baseline measurement period, based at least in part on a determination that reselection to a neighbor cell is more likely than if T_{low} is not satisfied, which conserves power and measurement relative to the baseline measurement period.

In some aspects, if the received power level of the serving cell is greater than the reselection threshold and the received power level of the neighbor cell satisfies the neighbor selection threshold, then the UE 120 may determine the determined measurement period based at least in part on the value Nₛₜₑₚ and a scaling factor. For example, the scaling factor may shorten the determined measurement period relative to if only Nₛₜₑₚ is used to determine the determined measurement period. As one example, the scaling factor may be 2, though other values may be used. The value of the scaling factor can be preconfigured for the UE 120, signaled by the BS 110, specified in a wireless communication standard, or the like.

In some aspects, if the received power level of the serving cell is lower than the reselection threshold (meaning that reselection from the serving cell is triggered), then the UE 120 may schedule one or more neighbor measurements on one or more neighbor cells. For example, the UE 120 may schedule one or more neighbor measurements on each neighbor cell whose received power level (e.g., Srxlev) satisfies the neighbor selection threshold. In some aspects, the UE 120 may schedule the one or more neighbor measurements to be performed in each DRX cycle (e.g., in a number of consecutive DRX cycles or until a suitable neighbor cell is selected). In this way, the UE 120 may reduce time spent out-of-service if the received power level of the serving cell is lower than the reselection threshold.

In some aspects, if the received power level of the serving cell is lower than the reselection threshold, and the received power level of the neighbor cell (e.g., the received power level of any neighbor cell) fails to satisfy the neighbor selection threshold, then the UE 120 may schedule one or more neighbor measurements on all neighbor cells identified by a neighbor cell list in DRX cycle. For example, the neighbor cell list may be indicated in the information shown by reference number 310, may be determined by the UE 120, or a combination thereof. In this way, the UE 120 may increase measurement activity if no suitable neighbor cell is identified, thereby reducing time spent out-of-service.

At 330, the UE 120 may perform one or more neighbor cell measurements in accordance with the determined measurement period. For example, the UE 120 may schedule the one or more neighbor cell measurements in accordance with the determined measurement period, and may perform the one or more neighbor cell measurements. The UE 120 may perform the one or more neighbor cell measurements based at least in part on a reference signal received from the neighbor cell, such as a synchronization signal block (SSB), a channel state information reference signal (CSI-RS), or the like. In some aspects, the UE 120 may perform a mobility operation, such as cell reselection, based at least in part on the one or more neighbor cell measurements. For example, the UE 120 may transmit, to the serving cell or the neighbor cell, information regarding the one or more neighbor cell measurements. The serving cell or the neighbor cell may configure a reselection process based at least in part on the one or more neighbor cell measurements.

As indicated above, FIG. 3 is provided as an example. Other examples may differ from what is described with regard to FIG. 3.

FIG. 4 is a diagram illustrating an example method 400 for the determination of the measurement period described in connection with reference number 320 of FIG. 3, in accordance with various aspects of the present disclosure. Example 400 involves a received power value for a serving sell (shown as “Srxlevserving”) and a received power value for a neighbor cell (shown as “SrxlevNR”). A given threshold is shown as T_{low} and a cell selection threshold is shown as T_{NW}. The operations of FIG. 4 may be performed by a UE 120.

At 405, the UE 120 may be in an LTE idle mode (e.g., an RRC idle mode associated with an LTE RAT). At 410, the UE 120 may receive SIB24, or a pseudo NR neighbor list (e.g., a neighbor cell list) may be configured. As shown, the UE 120 may determine whether the received power value of the serving cell satisfies a reselection threshold (e.g., is lower than the reselection threshold). If the received power value of the serving cell does not satisfy the reselection threshold (block 415—NO), then the UE 120 may determine whether the received power value of the neighbor cell satisfies the neighbor selection threshold (block 420). If the received power value of the neighbor cell satisfies the neighbor selection threshold (block 420—YES), then UE 120 may schedule measurement on each neighbor cell identified by the neighbor cell list per DRX cycle (block 425).

If the received power value of the serving cell satisfies the reselection threshold (e.g., is greater than the reselection threshold) (block 415—YES), then the UE 120 may determine whether the received power value of the neighbor cell satisfies the given threshold (block 430). If the received power value of the neighbor cell satisfies (e.g., is greater than) the given threshold (block 430—YES) and fails to satisfy the neighbor selection threshold (block 420—NO), then the UE 120 may set the measurement period to a maximum search/measurement period (block 435). If the received power value of the neighbor cell fails to satisfy the given threshold (block 430—NO), then the UE 120 may determine whether the received power value of the neighbor cell is less than the neighbor selection threshold (block 440). If the received power value of the neighbor cell is less than the neighbor selection threshold (block 440—YES), then the UE 120 may set the determined measurement period to be equal to (maximum search/measurement period)/Nₛₜₑₚ (block 445). If the received power value of the neighbor cell is not less than the neighbor selection threshold (block 440-NO), then the UE 120 may set the determined measurement period to be equal to (maximum search/measurement period)/(scaling factor*Nₛₜₑₚ) (block 450).

As indicated above, FIG. 4 is provided as an example. Other examples may differ from what is described with regard to FIG. 4.

FIG. 5 is a flowchart of an example method 500 of wireless communication, in accordance with various aspects of the present disclosure. The method 500 may be performed by, for example, a UE (e.g., UE 120).

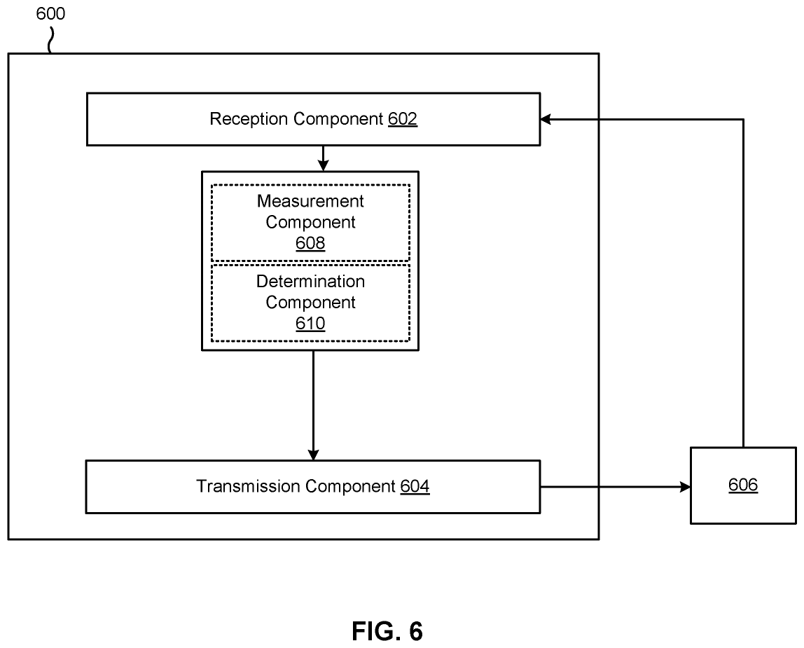

At 510, the UE may receive, from a serving cell, information indicating a measurement schedule for measurement of a neighbor cell. For example, the UE (e.g., using reception component 602, depicted in FIG. 6) may receive, from a serving cell, information indicating a measurement schedule for measurement of a neighbor cell, as described above in connection with, for example, FIG. 3 at 310 and FIG. 4 at 410. In some aspects, the measurement schedule may identify a baseline measurement period.

At 520, the UE may optionally (as indicated by a dashed border in FIG. 5) determine a measurement period. For example, the UE (e.g., using determination component 610, depicted in FIG. 6) may determine the measurement period based at least in part on a received power value associated with the serving cell and on comparing a received power value of the neighbor cell to a given threshold, as described above in connection with, for example, FIG. 3 at 320 and FIG. 4 generally.

At 530, the UE may perform one or more neighbor cell measurements in accordance with the determined measurement period. For example, the UE (e.g., using measurement component 608, depicted in FIG. 6) may perform one or more neighbor cell measurements in accordance with the determined measurement period. The determined measurement period may be determined by the UE, as described above in connection with, for example, FIG. 3 at 320 and FIG. 4 generally.

In some aspects, the determined measurement period is longer than a discontinuous reception cycle of the UE. In some aspects, the received power value associated with the serving cell is a cell selection receive level (Srxlev) value associated with the serving cell and the received power value associated with the neighbor cell is an Srxlev value associated with the neighbor cell.

In some aspects, the determined measurement period is a maximum measurement period (e.g., a maximum search or measurement (search/measurement) period) if the received power value associated with the serving cell is greater than a reselection threshold and the received power value associated with the neighbor cell is lower than the given threshold. In some aspects, the given threshold is lower than a neighbor selection threshold indicated by the information indicating the measurement schedule.

In some aspects, the information indicating the measurement schedule indicates a neighbor selection threshold associated with a cell reselection criterion. The method 500 may further include determining the determined measurement period to be shorter than a maximum measurement period if the received power value associated with the serving cell is greater than a reselection threshold, wherein the determined measurement period is determined using a scaling factor (as described at block 450) if the received power value associated with the neighbor cell is greater than the neighbor selection threshold, and the determined measurement period is determined without using the scaling factor (as described at block 445) if the received power value associated with the neighbor cell is not greater than the neighbor selection threshold.

In some aspects, the information indicating the measurement schedule indicates a neighbor selection threshold associated with a cell reselection criterion, and if the received power value associated with the serving cell is lower than a reselection threshold, and the method 500 further comprises scheduling the one or more neighbor cell measurements for each of one or more neighbor cells, including the neighbor cell, that are associated with respective received power values that satisfy the neighbor selection threshold. In some aspects, the one or more neighbor cell measurements are scheduled once per discontinuous reception cycle of the UE

In some aspects, if the received power value associated with the serving cell is lower than a reselection threshold and no neighbor cell of the UE is associated with a received power value greater than a neighbor selection threshold associated with a cell reselection criterion, the method 500 further comprises scheduling the one or more neighbor cell measurements for each of one or more neighbor cells identified by a neighbor cell list. In some aspects, the one or more neighbor cell measurements are scheduled once per discontinuous reception cycle of the UE.

In some aspects, the serving cell is associated with a first radio access technology and the neighbor cell is associated with a second radio access technology. In some aspects, the first radio access technology is Long Term Evolution and the second radio access technology is New Radio. In some aspects, the given threshold is determined by the UE or preconfigured for the UE. In some aspects, the determined measurement period is different than a baseline measurement period indicated by the measurement schedule.

Although FIG. 5 shows example blocks of method 500, in some aspects, method 500 may include additional blocks, fewer blocks, different blocks, or differently arranged blocks than those depicted in FIG. 5. Additionally, or alternatively, two or more of the blocks of method 500 may be performed in parallel.

FIG. 6 is a block diagram of an example apparatus 600 for wireless communication, in accordance with various aspects of the present disclosure. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include one or more of a measurement component 608 or a determination component 610, among other examples.

In some aspects, the apparatus 600 may be configured to perform one or more operations described herein in connection with FIGS. 3-4. Additionally, or alternatively, the apparatus 600 may be configured to perform one or more processes described herein, such as method 500 of FIG. 5, or a combination thereof. In some aspects, the apparatus 600 and/or one or more components shown in FIG. 6 may include one or more components of the UE described above in connection with FIG. 2. Additionally, or alternatively, one or more components shown in FIG. 6 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 606. In some aspects, the reception component 602 may include one or more antennas, a demodulator, a MIMO detector, a receive processor, a controller/processor, a memory, or a combination thereof, of the UE described above in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modulator, a transmit MIMO processor, a transmit processor, a controller/processor, a memory, or a combination thereof, of the UE described above in connection with FIG. 2. In some aspects, the transmission component 604 may be co-located with the reception component 602 in a transceiver.

The reception component 602 may receive, from a serving cell, information indicating a measurement schedule for measurement of a neighbor cell. The determination component 610 may determine a determined measurement period based at least in part on a received power value associated with the serving cell and on comparing a received power value of the neighbor cell to a given threshold. The measurement component 608 may perform one or more neighbor cell measurements in accordance with the determined measurement period. In some aspects, the measurement component 608 may schedule a neighbor cell measurement in accordance with the determined measurement period.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

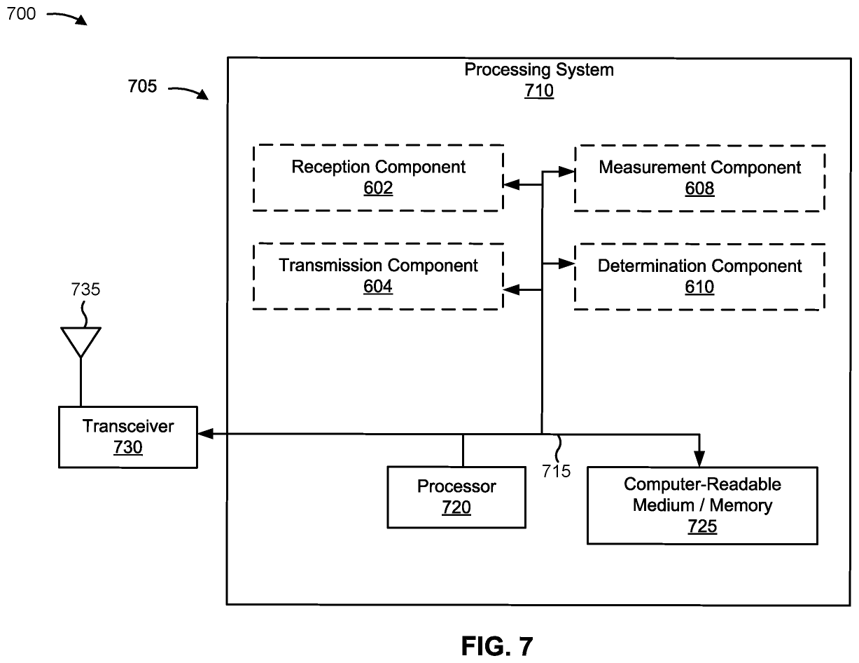

FIG. 7 is a diagram illustrating an example 700 of a hardware implementation for an apparatus 705 employing a processing system 710, in accordance with various aspects of the present disclosure. The apparatus 705 may be a UE.

The processing system 710 may be implemented with a bus architecture, represented generally by the bus 715. The bus 715 may include any number of interconnecting buses and bridges depending on the specific application of the processing system 710 and the overall design constraints. The bus 715 links together various circuits including one or more processors and/or hardware components, represented by the processor 720, the illustrated components, and the computer-readable medium/memory 725. The bus 715 may also link various other circuits, such as timing sources, peripherals, voltage regulators, and/or power management circuits.

The processing system 710 may be coupled to a transceiver 730. The transceiver 730 is coupled to one or more antennas 735. The transceiver 730 provides a means for communicating with various other apparatuses over a transmission medium. The transceiver 730 receives a signal from the one or more antennas 735, extracts information from the received signal, and provides the extracted information to the processing system 710, specifically the reception component 602. In addition, the transceiver 730 receives information from the processing system 710, specifically the transmission component 604, and generates a signal to be applied to the one or more antennas 735 based at least in part on the received information.

The processing system 710 includes a processor 720 coupled to a computer-readable medium/memory 725. The processor 720 is responsible for general processing, including the execution of software stored on the computer-readable medium/memory 725. The software, when executed by the processor 720, causes the processing system 710 to perform the various functions described herein for any particular apparatus. The computer-readable medium/memory 725 may also be used for storing data that is manipulated by the processor 720 when executing software. The processing system further includes at least one of the illustrated components. The components may be software modules running in the processor 720, resident/stored in the computer readable medium/memory 725, one or more hardware modules coupled to the processor 720, or some combination thereof.

In some aspects, the processing system 710 may be a component of the UE 120 and may include the memory 282 and/or at least one of the TX MIMO processor 266, the RX processor 258, and/or the controller/processor 280. In some aspects, the apparatus 705 for wireless communication includes means for receiving, from a serving cell, information indicating a measurement schedule for measurement of a neighbor cell; means for determining a measurement period; means for performing one or more neighbor cell measurements in accordance with a determined measurement period; means for determining the determined measurement period to be shorter than a maximum search or measurement (search/measurement) period at least in part on the received power value associated with the serving cell being greater than a reselection threshold and based at least in part on the received power value associated with the neighbor cell failing to satisfy the neighbor selection threshold; means for determining, based at least in part on the received power value associated with the serving cell being greater than a reselection threshold and based at least in part on the received power value associated with the neighbor cell satisfying the neighbor selection threshold, the determined measurement period to be shorter than a maximum search/measurement period in accordance with a scaling factor; means for scheduling, based at least in part on the received power value associated with the serving cell being lower than the reselection threshold, the one or more neighbor cell measurements for each of one or more neighbor cells, including the neighbor cell, that are associated with respective received power values that satisfy the neighbor selection threshold; and means for scheduling, based at least in part on the received power value associated with the serving cell being lower than the reselection threshold and no neighbor cell of the UE being associated with a received power value that satisfies a neighbor selection threshold, the one or more neighbor cell measurements for each of one or more neighbor cells identified by a neighbor cell list. The aforementioned means may be one or more of the aforementioned components of the apparatus 600 and/or the processing system 710 of the apparatus 705 configured to perform the functions recited by the aforementioned means. As described elsewhere herein, the processing system 710 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 7 is provided as an example. Other examples may differ from what is described in connection with FIG. 7.

The following provides an overview of some aspects of the present disclosure:

Aspect 1: A method of wireless communication performed by a user equipment (UE), comprising: receiving, from a serving cell, information indicating a measurement schedule for measurement of a neighbor cell; determining a measurement period for the measurement schedule based at least in part on a received power value associated with the serving cell and on comparing the received power value of the neighbor cell to a given threshold; and performing one or more neighbor cell measurements in accordance with the determined measurement period.

Aspect 2: The method of aspect 1, wherein the determined measurement period is longer than a discontinuous reception cycle of the UE.

Aspect 3: The method of any of aspects 1-2, wherein the received power value associated with the serving cell is a cell selection receive level (Srxlev) value associated with the serving cell and the received power value associated with the neighbor cell is an Srxlev value associated with the neighbor cell.

Aspect 4: The method of any of aspects 1-3, wherein the determined measurement period is a maximum measurement period if the received power value associated with the serving cell is greater than a reselection threshold and the received power value associated with the neighbor cell is lower than the given threshold.

Aspect 5: The method of any of aspects 1-4, wherein the given threshold is lower than a neighbor selection threshold indicated by the information indicating the measurement schedule.

Aspect 6: The method of any of aspects 1-5, wherein the information indicating the measurement schedule indicates a neighbor selection threshold associated with a cell reselection criterion, and wherein the method further comprises: determining the determined measurement period to be shorter than a maximum measurement period if the received power value associated with the serving cell is greater than a reselection threshold, wherein the determined measurement period is determined using a scaling factor if the received power value associated with the neighbor cell is greater than the neighbor selection threshold, and the determined measurement period is determined without using the scaling factor if the received power value associated with the neighbor cell is not greater than the neighbor selection threshold.

Aspect 7: The method of any of aspects 1-6, wherein the information indicating the measurement schedule indicates a neighbor selection threshold associated with a cell reselection criterion, and if the received power value associated with the serving cell is lower than a reselection threshold, the method further comprises: scheduling the one or more neighbor cell measurements for each of one or more neighbor cells, including the neighbor cell, that are associated with respective received power values that satisfy the neighbor selection threshold.

Aspect 8: The method of aspect 7, wherein the one or more neighbor cell measurements are scheduled once per discontinuous reception cycle of the UE.

Aspect 9: The method of any of aspects 1-8, wherein, if the received power value associated with the serving cell is lower than a reselection threshold and no neighbor cell of the UE is associated with a received power value greater than a neighbor selection threshold associated with a cell reselection criterion, the method further comprises: scheduling the one or more neighbor cell measurements for each of one or more neighbor cells identified by a neighbor cell list.

Aspect 10: The method of aspect 9, wherein the one or more neighbor cell measurements are scheduled once per discontinuous reception cycle of the UE.

Aspect 11: The method of any of aspects 1-10, wherein the serving cell is associated with a first radio access technology and the neighbor cell is associated with a second radio access technology.

Aspect 12: The method of aspect 11, wherein the first radio access technology is Long Term Evolution and the second radio access technology is New Radio.

Aspect 13: The method of any of aspects 1-12, wherein the given threshold is determined by the UE or preconfigured for the UE.

Aspect 14: The method of any of aspects 1-13, wherein the determined measurement period is different than a baseline measurement period indicated by the measurement schedule.

Aspect 15: An apparatus for wireless communication at a device, comprising a processor; memory coupled with the processor; and instructions stored in the memory and executable by the processor to cause the apparatus to perform the method of one or more aspects of aspects 1-14.

Aspect 16: A device for wireless communication, comprising a memory and one or more processors coupled to the memory, the memory and the one or more processors configured to perform the method of one or more aspects of aspects 1-14.

Aspect 17: An apparatus for wireless communication, comprising at least one means for performing the method of one or more aspects of aspects 1-14.

Aspect 18: A non-transitory computer-readable medium storing code for wireless communication, the code comprising instructions executable by a processor to perform the method of one or more aspects of aspects 1-14.

Aspect 19: A non-transitory computer-readable medium storing a set of instructions for wireless communication, the set of instructions comprising one or more instructions that, when executed by one or more processors of a device, cause the device to perform the method of one or more aspects of aspects 1-14.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a serving cell, information indicating a measurement schedule for measurement of a neighbor cell;
determining a measurement period for the measurement schedule based at least in part on a received power value associated with the serving cell and on comparing the received power value of the neighbor cell to a given threshold; and
performing one or more neighbor cell measurements in accordance with the determined measurement period.

2. The method of claim 1, wherein the determined measurement period is longer than a discontinuous reception cycle of the UE.

3. The method of claim 1, wherein the received power value associated with the serving cell is a cell selection receive level (Srxlev) value associated with the serving cell and the received power value associated with the neighbor cell is an Srxlev value associated with the neighbor cell.

4. The method of claim 1, wherein the determined measurement period is a maximum measurement period if the received power value associated with the serving cell is greater than a reselection threshold and the received power value associated with the neighbor cell is lower than the given threshold.

5. The method of claim 1, wherein the given threshold is lower than a neighbor selection threshold indicated by the information indicating the measurement schedule.

6. The method of claim 1, wherein the information indicating the measurement schedule indicates a neighbor selection threshold associated with a cell reselection criterion, and wherein the method further comprises:
determining the determined measurement period to be shorter than a maximum measurement period if the received power value associated with the serving cell is greater than a reselection threshold, wherein the determined measurement period is determined using a scaling factor if the received power value associated with the neighbor cell is greater than the neighbor selection threshold, and the determined measurement period is determined without using the scaling factor if the received power value associated with the neighbor cell is not greater than the neighbor selection threshold.

7. The method of claim 1, wherein the information indicating the measurement schedule indicates a neighbor selection threshold associated with a cell reselection criterion, and if the received power value associated with the serving cell is lower than a reselection threshold, the method further comprises:
scheduling the one or more neighbor cell measurements for each of one or more neighbor cells, including the neighbor cell, that are associated with respective received power values that satisfy the neighbor selection threshold.

8. The method of claim 7, wherein the one or more neighbor cell measurements are scheduled once per discontinuous reception cycle of the UE.

9. The method of claim 1, wherein, if the received power value associated with the serving cell is lower than a reselection threshold and no neighbor cell of the UE is associated with a received power value greater than a neighbor selection threshold associated with a cell reselection criterion, the method further comprises:
scheduling the one or more neighbor cell measurements for each of one or more neighbor cells identified by a neighbor cell list.

10. The method of claim 9, wherein the one or more neighbor cell measurements are scheduled once per discontinuous reception cycle of the UE.

11. The method of claim 1, wherein the serving cell is associated with a first radio access technology and the neighbor cell is associated with a second radio access technology.

12. The method of claim 11, wherein the first radio access technology is Long Term Evolution and the second radio access technology is New Radio.

13. The method of claim 1, wherein the given threshold is determined by the UE or preconfigured for the UE.

14. The method of claim 1, wherein the determined measurement period is different than a baseline measurement period indicated by the measurement schedule.

15. A user equipment (UE) for wireless communication, comprising:
a memory; and
one or more processors operatively coupled to the memory, the memory and the one or more processors configured to:
receive, from a serving cell, information indicating a measurement schedule for measurement of a neighbor cell;
determine a measurement period for the measurement schedule based at least in part on a received power value associated with the serving cell and on comparing the received power value of the neighbor cell to a given threshold; and
perform one or more neighbor cell measurements in accordance with the determined measurement period.

16. The UE of claim 15, wherein the determined measurement period is longer than a discontinuous reception cycle of the UE.

17. The UE of claim 15, wherein the received power value associated with the serving cell is a cell selection receive level (Srxlev) value associated with the serving cell and the received power value associated with the neighbor cell is an Srxlev value associated with the neighbor cell.

18. The UE of claim 15, wherein the determined measurement period is a maximum measurement period if the received power value associated with the serving cell is greater than a reselection threshold and the received power value associated with the neighbor cell is lower than the given threshold.

19. The UE of claim 15, wherein the given threshold is lower than a neighbor selection threshold indicated by the information indicating the measurement schedule.

20. The UE of claim 15, wherein the information indicating the measurement schedule indicates a neighbor selection threshold associated with a cell reselection criterion, and wherein the one or more processors are configured to:
determine the determined measurement period to be shorter than a maximum measurement period if the received power value associated with the serving cell is greater than a reselection threshold, wherein the determined measurement period is determined using a scaling factor if the received power value associated with the neighbor cell is greater than the neighbor selection threshold, and the determined measurement period is determined without using the scaling factor if the received power value associated with the neighbor cell is not greater than the neighbor selection threshold.

21. The UE of claim 15, wherein the information indicating the measurement schedule indicates a neighbor selection threshold associated with a cell reselection criterion, and if the received power value associated with the serving cell is lower than a reselection threshold, the one or more processors are further configured to:
schedule the one or more neighbor cell measurements for each of one or more neighbor cells, including the neighbor cell, that are associated with respective received power values that satisfy the neighbor selection threshold.

22. The UE of claim 15, wherein, if the received power value associated with the serving cell is lower than a reselection threshold and no neighbor cell of the UE is associated with a received power value greater than a neighbor selection threshold associated with a cell reselection criterion, the one or more processors are further configured to:
schedule the one or more neighbor cell measurements for each of one or more neighbor cells identified by a neighbor cell list.

23. A non-transitory computer-readable medium storing a set of instructions for wireless communication, the set of instructions comprising:
one or more instructions that, when executed by one or more processors of a user equipment (UE), cause the UE to:
receive, from a serving cell, information indicating a measurement schedule for measurement of a neighbor cell;
determine a measurement period for the measurement schedule based at least in part on a received power value associated with the serving cell and on comparing the received power value of the neighbor cell to a given threshold; and
perform one or more neighbor cell measurements in accordance with the determined measurement period.

24. The non-transitory computer-readable medium of claim 23, wherein the information indicating the measurement schedule indicates a neighbor selection threshold associated with a cell reselection criterion, and wherein the one or more instructions further cause the UE to:
determine the determined measurement period to be shorter than a maximum measurement period if the received power value associated with the serving cell is greater than a reselection threshold, wherein the determined measurement period is determined using a scaling factor if the received power value associated with the neighbor cell is greater than the neighbor selection threshold, and the determined measurement period is determined without using the scaling factor if the received power value associated with the neighbor cell is not greater than the neighbor selection threshold.

25. The non-transitory computer-readable medium of claim 23, wherein the one or more instructions further cause the UE to:
schedule the one or more neighbor cell measurements for each of one or more neighbor cells, including the neighbor cell, that are associated with respective received power values that satisfy the neighbor selection threshold.

26. The non-transitory computer-readable medium of claim 23, wherein, if the received power value associated with the serving cell is lower than a reselection threshold and no neighbor cell of the UE is associated with a received power value greater than a neighbor selection threshold associated with a cell reselection criterion, the one or more instructions further cause the UE to:
schedule the one or more neighbor cell measurements for each of one or more neighbor cells identified by a neighbor cell list.

27. An apparatus for wireless communication, comprising:
means for receiving, from a serving cell, information indicating a measurement schedule for measurement of a neighbor cell;
means for determining a measurement period for the measurement schedule based at least in part on a received power value associated with the serving cell and on comparing the received power value of the neighbor cell to a given threshold; and
means for performing one or more neighbor cell measurements in accordance with the determined measurement period.

28. The apparatus of claim 27, wherein the information indicating the measurement schedule indicates a neighbor selection threshold associated with a cell reselection criterion, and wherein the apparatus further comprises:
means for determining the determined measurement period to be shorter than a maximum measurement period if the received power value associated with the serving cell is greater than a reselection threshold

29. The apparatus of claim 27, further comprising:
means for scheduling the one or more neighbor cell measurements for each of one or more neighbor cells, including the neighbor cell, that are associated with respective received power values that satisfy the neighbor selection threshold.

30. The apparatus of claim 27, wherein, if the received power value associated with the serving cell is lower than a reselection threshold and no neighbor cell of the UE is associated with a received power value greater than a neighbor selection threshold associated with a cell reselection criterion, the apparatus further comprises:
means for scheduling the one or more neighbor cell measurements for each of one or more neighbor cells identified by a neighbor cell list.
